(19) United States
(12) Patent Application Publication
(10) Pub. No.: US 2007/0133229 A1
(43) Pub. Date: Jun. 14, 2007

(54) Backlight module with heat-dissipating microstructures and liquid crystal display using the same

(75) Inventor: Ming-Hung Tsai, MiaoLi (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/636,737

(22) Filed: Dec. 11, 2006

(30) Foreign Application Priority Data
Dec. 9, 2005 (TW) 94143581

(51) Int. Cl. F21V 7/04

(52) U.S. Cl. 362/633

(57) ABSTRACT

An exemplary backlight module (2) includes a metal frame (27), and a light source (21). The metal frame includes inner side and a containing space. The light source is received in the containing space. The inner side includes microstructures (271) configured to optimize absorption of heat thereat.

### FIELD OF THE INVENTION

The present invention relates to liquid crystal displays and backlight modules of liquid crystal displays, and more particularly to a backlight module having a microstructure configured to facilitate dissipation of heat away from optical components of the backlight module.

### BACKGROUND

Liquid crystal displays (LCDs) are so-called non-self-emitting displays. Therefore an LCD panel of an LCD device requires a light source in order to be able to provide images for viewing. In some LCD devices, the needed light is obtained from the ambient environment. In other LCD devices, a backlight module is installed behind the LCD panel. A backlight module typically includes a cold cathode fluorescent lamp (CCFL) serving as an original light source, and a light guide plate for converting light emitted by the CCFL into a planar light source. The light guide plate outputs the planar light to the LCD panel.

Referring to FIG. 9, this is a schematic, side cross-sectional view of a conventional backlight module 10 of a liquid crystal display. The backlight module 10 includes a light source 11, a light guide plate 12, a first brightness enhancement film 13, a second brightness enhancement film 14, a diffuser 15, a reflective brace 16, and a metal frame 17. The frame 17 contains the reflective brace 16, the light source 11, the light guide plate 12, the first and second brightness enhancement films 13, 14, and the diffuser 15.

The light guide plate 12 includes a light emitting side 121, and a light entering side 122 substantially perpendicular to the light emitting side 121. The light source 11 is arranged adjacent to the light entering side 122. The light source 11 emits light beams into the light entering side 122, and also generates heat as a byproduct of this process. The reflective brace 16 has a generally rectangular profile, but includes an opening 161 at a top thereof. The reflective brace 16 also includes a containing space receiving the light source 11 and the light guide plate 12 therein. The opening 161 corresponds to the light emitting side 121 of the light guide plate 12. Light beams emitted from the light source 11 enter the light guide plate 12 via the light entering side 122. Some of the light beams transmit directly through the light guide plate 12 and emit from the light emitting side 121. Other light beams are first reflected by the reflective brace 16 before emitting from the light emitting side 121. Thus the reflective brace 16 increases the light utilization efficiency of the backlight module 10.

The second brightness enhancement film 14 is disposed on the reflective brace 16, and the first brightness enhancement film 13 is disposed on the second brightness enhancement film 14. The diffuser 15 is disposed on the first brightness enhancement film 13. The first and second brightness enhancement films 13, 14 are configured to gather received light, and the diffuser 15 is configured to uniformly scatter received light.

An inner surface of the frame 17 is smooth. Therefore heat radiation generated by the light source 11 may be reflected to the light guide plate 12 by the frame 17. However, the backlight module 10 is generally a closed assembly, and the heat tends to accumulate therein. Thus optical elements such as the light guide plate 12 and the second brightness enhancement film 14 are liable to be damaged by the accumulated heat.

Accordingly, what is needed is a backlight module of a liquid crystal display configured to overcome the above-described problems.

### SUMMARY

An exemplary backlight module includes a frame and a light source. The frame includes an inner side and a containing space. The light source is received in the containing space. The inner side includes a plurality of microstructures configured to optimize absorption of heat thereat.

A detailed description of embodiments of the present invention is given below with reference to the accompanying drawings.

### BRIEF DESCRIPTION OF THE DRAWINGS

In the drawings, all the views are schematic.

FIG. 1 is a side cross-sectional view of a liquid crystal display in accordance with a first embodiment of the present invention.

FIG. 2 is an enlarged view of a circled portion II of FIG. 1.

FIG. 3 is an enlarged, isometric view of part of a bottom of a frame of the liquid crystal display of FIG. 1.

FIG. 4 is an isometric view of part of a bottom of a frame of a liquid crystal display in accordance with a second embodiment of the present invention.

FIG. 5 is an isometric view of part of a bottom of a frame of a liquid crystal display in accordance with a third embodiment of the present invention.

FIG. 6 is an isometric view of part of a bottom of a frame of a liquid crystal display in accordance with a fourth embodiment of the present invention.

FIG. 7 is an isometric view of part of a bottom of a frame of a liquid crystal display in accordance with a fifth embodiment of the present invention.

FIG. 8 is an isometric view of part of a bottom of a frame of a liquid crystal display in accordance with a sixth embodiment of the present invention.

FIG. 9 is a side cross-sectional view of a conventional backlight module.

### DETAILED DESCRIPTION OF PREFERRED EMBODIMENTS

Referring to FIG. 1, this shows a schematic, side cross-sectional view of a liquid crystal display 2 in accordance with a first embodiment of the present invention. The liquid crystal display 2 includes a display panel 30, and a backlight module 20 providing light for the display panel 30.

The backlight module 20 includes a light source 21, a light guide plate 22, a first brightness enhancement film 23, a second brightness enhancement film 24, a diffuser 25, a reflective brace 26, and a metal frame 27.

The light guide plate 22 includes a light emitting side 221, and a light entering side 222 substantially perpendicular to the light emitting side 221. The light source 21, for example, cold cathode fluorescent lamp (CCFL), which is arranged adjacent to the light entering side 222. The light source 21 emits light beams into the light entering side 222, and also generates heat as a byproduct of this process. The reflective brace 26 shapes has a generally rectangular profile, but and includes an opening 261 at a top thereof. The reflective brace 26 also includes a containing space containing the light source 21 and a light guide plate 22 therein. The opening 261 is corresponds to the light emitting side 221 of the light guide plate 22. Light beams emitted from the light source 21 enters the light guide plate 22, part via the light entering side 222. Some of the light beams transmit directly through the light guide plate 22 and emit from the light emitting side 221. Other light beams are first reflected by the reflective brace 26, and then, emitting out of the light emitting side 221. Thus the reflective brace 26 increases the light utilization efficiency of the backlight module 20.

The second brightness enhancement film 24 is disposed on the reflective brace 26, and, the first brightness enhancement film 23 is disposed on the second brightness enhancement film 24. The diffuser 25 is disposed on the first brightness enhancement film 23. The first and second brightness enhancement films 23, 24 are configured to gather received light, and the diffuser 25 is configured to uniformly scatter received light.

The frame 27 is made from metal having high heat conductivity, for example, stainless steel (specification number SU430), steel electrogalvanized cold rolled coil (SECC), hot dip galvanized steel sheet in coil (SGCC), aluminum, magnesium, copper, iron, or any suitable alloy thereof.

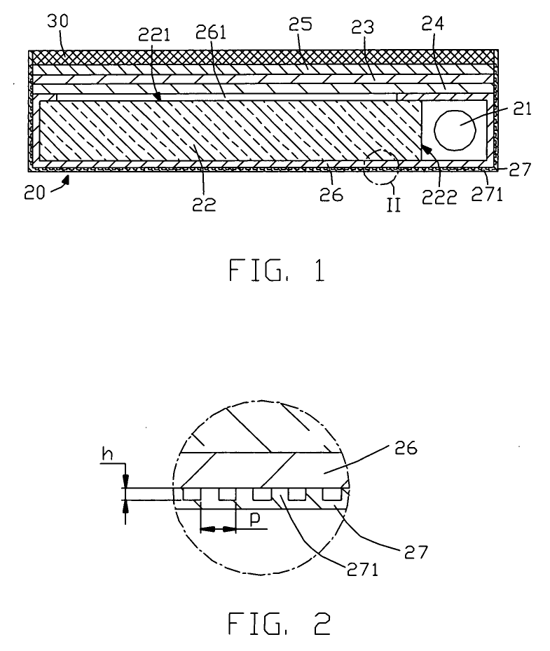

Referring to FIG. 2, this shows a plurality of microstructures formed at an inner side of the frame 27. In the first embodiment, the microstructures are strip-shaped protrusions 271 that are parallel to each other. Each strip-shaped protrusion 271 has a rectangular transverse cross-section. The protrusions 271 contact the reflective brace 26. ‘p’ is a period between the protrusions 271, and ‘h’ is a height of the protrusions 271.

Referring also to FIG. 3, a series, of consecutive protrusions 271 can be considered to define a square wave. Generally, the smaller a period of the square wave, the greater the thermal radiation absorption capability of the frame 27.

An equation of thermal characteristics of the square wave is as follows:

$$Sin θ n = Sin θ i + n \cdot \frac{λ}{Λ}$$

wherein θn is the nth level diffraction angle of the thermal radiation, θi is the incident angle, λ is the wavelength of the thermal radiation, and Λ is the period of the protrusions 271.

Preferably, the period of the protrusions 271 is less than the wavelength of thermal radiation transmitted to the frame 27. That is, the protrusions 271 preferably have the characteristic akin to a one-dimensional sub-wavelength arrangement 3. In particular, θi and θn are both acute angles. Therefore, the values of Sin θi and Sin θn are both between 0 and 1. Accordingly, 0≦Sin θi≦1, 0≦Sinθn≦1, and λ/Λ>1.

According to the above, when the protrusions 271 have the characteristic akin to a one-dimensional sub-wavelength optical element, the protrusions 271 do not generate anything greater than first-level diffraction. In other words, the high-level diffraction of thermal radiation from the protrusions 271 of the frame 27 can be avoided.

In general, the frame 27 can reflect or absorb thermal radiation generated from the light source 21. As detailed above, the inner side of the frame 27 has the protrusions 271 disposed thereat, unlike the smooth inner side of the above-described conventional frame 17. Therefore, reflection of thermal radiation by the frame 27 is reduced, and absorption of the thermal radiation by the frame 27 can be increased.

Further, a general blackbody radiation equation is as follows:

$$Iv = \frac{2 π h {v}^{3}}{{c}^{2}} \frac{1}{{ⅇ}^{hv / kT}} , h = 6.625 {ⅇ}^{- 34} ( J \cdot S ) ; k = 1.3805 {ⅇ}^{- 23} ( J / K )$$

wherein v is the wavelength of radiation, T is the temperature of radiation, c is the speed of light, and Iv is the energy of radiation.

According to the equation above, the spectrum of radiation energy shifts to short wavelengths with an increase in the temperature.

A precise desired configuration of the protrusions 271 can be obtained by simplification of the above equation. In particular, this can be done by estimating the wavelength of the maximum blackbody radiation value at different temperatures via Wien's law as follows:

$$V max = \frac{2.82 kT}{h}$$

The wavelength of the maximum blackbody radiation is estimated and shown in table 1 as follows:

TABLE 1

| | |
|---|---|
| Temperature | Wavelength |

| ° C. | ° K | μm |
|---|---|---|
| −40 | 233 | 21.913 |
| −30 | 243 | 21.011 |
| 25 | 298 | 17.133 |
| 27 | 300 | 17.019 |
| 60 | 333 | 15.333 |
| 85 | 358 | 14.262 |
| 95 | 368 | 13.874 |
| 100 | 373 | 13.688 |
| 120 | 393 | 12.992 |
| 150 | 423 | 12.070 |
| 200 | 473 | 10.798 |

For example, as seen, the wavelength of the maximum blackbody radiation at 27° C. is 17.019 μm, at 60° C. is 15.333 μm, at 85° C. is 14.262 μm, at 95° C. is 13.874 μm, at 100° C. is 13.688 μm, and at 120° C. is 12.992 μm.

According to table 1, when the period of the protrusions 271 is configured to be less than 14.262 μm (the maximum wavelength of the blackbody radiation under 85° C.), for example, 13.874 μm or 13.688 μm, the high-level diffraction generated at or below 85° C. can be reduced. Accordingly, an elevated temperature inside the liquid crystal display 2 caused by operation of the light source 21 can be reduced.

A ratio of the height ‘h’ and the period ‘p’ of the protrusions 271 is controlled to be between 1 and 2.5. When said ratio is less than 1, the thermal radiation reflection of the protrusions 271 is inefficient.

In summary, according to the above parameters, one preferred period of the protrusions 271 is less than 14.262 μm. Further, in general, the temperature of the protrusions 271 near the light source 21 is higher than the temperature of the protrusions 271 further away from the light source 21. Accordingly, in an alternative embodiment, the period of the protrusions 271 can be varied according the varying distances of the protrusions 271 to the light source 21. In one example, the period of proximal protrusions 271 near the light source 21 can be configured according to the above-described parameters regarding the wavelength of the maximum blackbody radiation, whereas the period of distal protrusions 271 further away from the light source 21 can be configured to be greater than the period of the proximal protrusions 271.

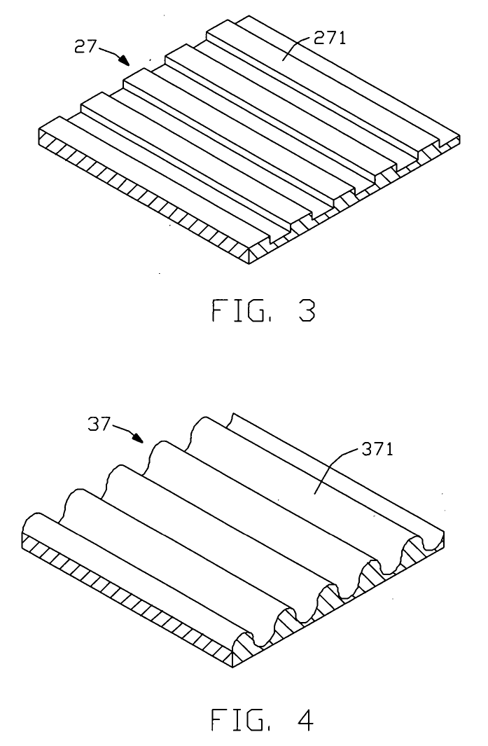

Referring to FIG. 4, this is a schematic, isometric view of part of a bottom of a frame 37 of a liquid crystal display in accordance with a second embodiment of the present invention. The frame 37 is similar to the frame 27 of the first embodiment. However, the frame 37 includes a plurality of strip-shaped protrusions 371, each of which is wavy. The protrusions 371 are arranged parallel to each other and cooperatively define a smooth waveform. For example, the waveform frame 37 defined by the protrusions 371 can be a sine wave.

Referring to FIG. 5, this is a schematic, isometric view of part of a bottom of a frame 47 of a liquid crystal display in accordance with a third embodiment of the present invention. The frame 47 is similar to the frame 27 of the first embodiment. However, the frame 47 includes a plurality of strip-shaped protrusions 471, each of which has a triangular profile. The protrusions 471 are arranged parallel to each other and cooperatively define a triangular waveform.

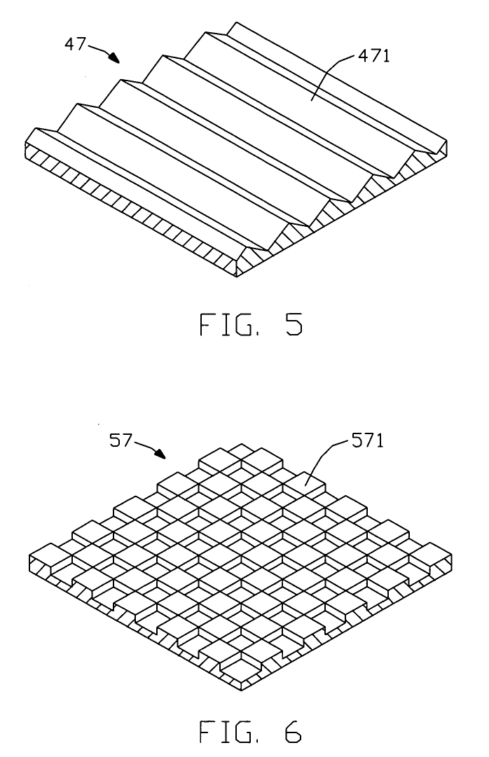

Referring to FIG. 6, this is a schematic, isometric view of part of a bottom of a frame 57 of a liquid crystal display in accordance with a fourth embodiment of the present invention. The frame 57 is similar in principle to the frame 27 of the first embodiment. However, the frame 57 includes a plurality of square protrusions 571. The protrusions 571 are arranged in a matrix, whereby the four comers of each protrusion 571 adjoin four comers of four corresponding adjacent protrusions 571. Thereby, the matrix of protrusions 571 also defines a corresponding matrix of indentations (not labeled), each indentation being bordered by four corresponding protrusions 571.

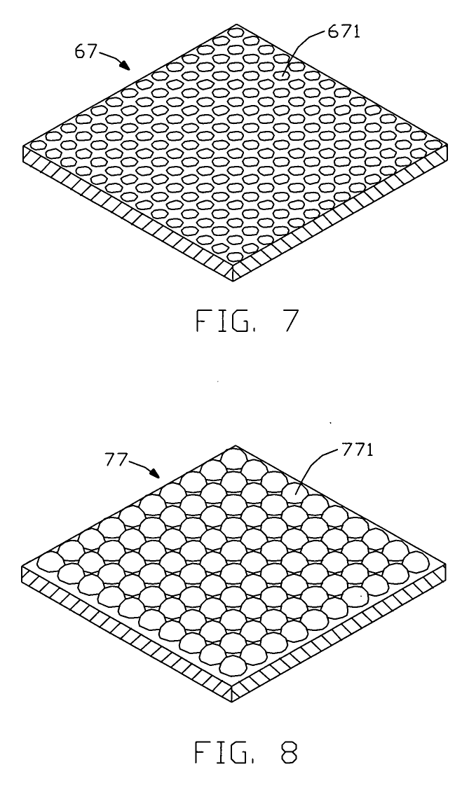

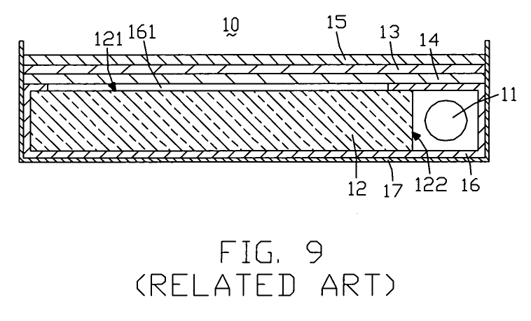

Referring to FIG. 7, this is a schematic, isometric view of part of a bottom of a frame 67 of a liquid crystal display in accordance with a fifth embodiment of the present invention. The frame 67 is similar in principle to the frame 57 of the fourth embodiment. However, the frame 67 includes a plurality of hemispherical indentations 671 arranged in a matrix.

Referring to FIG. 8, this is a schematic, isometric view of part of a bottom of a frame 77 of a liquid crystal display in accordance with a sixth embodiment of the present invention. The frame 77 is similar in principle to the frame 57 of the fourth embodiment. However, the frame 77 includes a plurality of hemispherical protrusions 771 arranged in a matrix.

In alternative embodiments, the protrusions 271, 371, 471, 571, 771 and the indentations 671 can be allocated in equality to a two dimensional structure. Further, the protrusions 271, 371, 471, 571, 771 and the indentations 671 can have any of various other suitable shapes and configurations.

To summarize one preferred generic embodiment, a period of the micro reflection structures can be configured to be less than 14.262 μm, whereby high-level diffraction of thermal radiation by the frame can be avoided. Accordingly, the temperature of the liquid crystal display can be controlled to be under 85° C., and the risk of heat damaging optical components within the liquid crystal display 2 can be reduced.

While preferred and exemplary embodiments have been described above, it is to be understood that the embodiments are not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A backlight module, comprising:
a frame comprising an inner side and a containing space; and
a light source received in the containing space;
wherein the inner side comprises a plurality of microstructures configured to optimize absorption of heat thereat.

2. The backlight module as claimed in claim 1, wherein the microstructures are waved stripped protrusions.

3. The backlight module as claimed in claim 1, wherein the microstructures are rectangular stripped protrusions.

4. The backlight module as claimed in claim 1, wherein the microstructures are square protrusions.

5. The backlight module as claimed in claim 1, wherein allocation of the micro reflect is in equality to a one-dimensional wave.

6. The backlight module as claimed in claim 5, wherein period of the one-dimensional wave is less than 14.262 μm.

7. The backlight module as claimed in claim 5, wherein period of the one-dimensional wave is 13.874 μm.

8. The backlight module as claimed in claim 1, wherein allocation of the micro reflect is in equality to a two-dimensional wave.

9. The backlight module as claimed in claim 8, wherein period of the two-dimensional wave is less than 14.262 μm.

10. The backlight module as claimed in claim 8, wherein period of the two-dimensional wave is 13.874 μm.

11. A liquid crystal display, comprising:
a display panel; and
a backlight module adjacent to the display panel and configured for illuminating the display panel, the backlight module comprising:
a frame having an inner side and a containing space; and
a light source received in the containing space;
wherein the inner side comprises a plurality of microstructures configured to optimize absorption of heat generated from the light source.

12. The liquid crystal display as claimed in claim 11, wherein the microstructures are stripped protrusions.

13. The liquid crystal display as claimed in claim 11, wherein the microstructures are wave stripped protrusions.

14. The liquid crystal display as claimed in claim 11, wherein the microstructures are square protrusions.

15. The liquid crystal display as claimed in claim 11, wherein allocation of the micro reflect is in equality to a one-dimensional wave.

16. The liquid crystal display as claimed in claim 15, wherein period of the one-dimensional wave is less than 14.262 μm.

17. The liquid crystal display as claimed in claim 15, wherein period of the one-dimensional wave is 13.874 μm.

18. The liquid crystal display as claimed in claim 11, wherein allocation of the micro reflect is in equality to a two-dimensional wave.

19. The liquid crystal display as claimed in claim 18, wherein period of the two-dimensional wave is less than 14.262 μm.

20. A backlight module, comprising:
a frame comprising a containing space; and
a light guide plate received in the containing space;
wherein the frame further defines an inner side facing said light guide plate and comprising a plurality of microstructures configured to optimize absorption of heat thereat.
